(19) United States
(12) Patent Application Publication
(10) Pub. No.: US 2013/0074716 A1
(43) Pub. Date: Mar. 28, 2013

(54) METHOD OF PRODUCING SEPARATOR PLATE FOR FUEL CELL AND FUEL CELL UTILIZING THE SAME

(71) Applicants: Tokyo Metropolitan Industrial Technology Researc, Tokyo (JP); Paramount Energy Laboratory Ltd., Tokyo (JP)

(72) Inventors: Yoichi ITO, Tokyo (JP); Hiroshi Ueno, Tokyo (JP); Tamotsu Muto, Tokyo (JP)

(73) Assignees: Paramount Energy Laboratory Ltd., Tokyo (JP); Tokyo Metropolitan Industrial Technology Research Instititute, Tokyo (JP)

(21) Appl. No.: 13/671,701

(22) Filed: Nov. 8, 2012

(30) Foreign Application Priority Data
Jun. 27, 2007 (JP) 2007-169390

(51) Int. Cl. B41M 3/00

(52) U.S. Cl. CPC B41M 3/00
USPC 101/129

(57) ABSTRACT

A pattern of a reaction gas flow passage in a separator plate of a fuel cell is formed by screen printing with high accuracy. The invention relates to a method of producing a separator plate for fuel cell, the method including forming a partition wall (11) having a predetermined pattern which is to be a reaction gas flow passage on a base plate (10a), wherein two or more coats of an ink composition containing a conductive material are laminated on the base plate by screen printing to form conductive ink layers (11a to 11c) having a predetermined thickness as the partition wall (11).

### CROSS-REFERENCE TO RELATED APPLICATIONS

This application is a continuation-in-part of copending U.S. patent application Ser. No. 12/601,118, filed on Nov. 20, 2009, which was a national-stage application claiming a right of priority under 35 U.S.C. Section 365 of PCT International Application No. JP2008/061,295, filed on Jun. 20, 2008, which claimed the priority of Japanese Application 2007-169390, filed on Jun. 27, 2007.

### TECHNICAL FIELD

The present invention relates to a method of producing a separator plate for fuel cell and a fuel cell utilizing the separator plate, and particularly to a method of producing a separator plate for polymer electrolyte membrane fuel cells (PEMFC) used in, for example, automobile, domestic and portable electronic devices, a separator plate obtained by the production method and a fuel cell using the separator plate.

### BACKGROUND ART

PEMFC have a higher output density than other fuel systems and therefore, studies have been made concerning these PEMFC for use as power sources of automobiles and as mobile power sources. Here, the structure of a unit cell of the PEMFC is shown in FIG. 13. A cell 1 includes a hydrogen electrode 5 provided with a support current collector 5a and an oxygen electrode 7 provided with a support current collector 7a, these electrodes being disposed on each side of an electrolyte membrane 3 and integrated to form a membrane/electrode assembly (MEA). The electromotive force of this unit cell 1 is usually about 0.6 to 1.0 V and therefore, two or more units of these cells 1 are laminated to obtain a desired output. A fuel cell body is therefore referred to as a cell stack because it is produced by laminating these pluralities of unit cells 1 and, a separator plate 10 is interposed between the adjacent unit cells 1.

Grooves having a depth of 1 mm to a little less than 1 mm are formed by digging on the surface or backside or both sides of the separator plate 10 for permitting hydrogen and oxygen (air) to flow therethrough as a reaction gas, respectively. It is necessary for the separator plate 10 to have gas impermeability because it is necessary for the reaction gas to be supplied to the entire reaction surface without allowing any mixing of the gases. Also, it is necessary for the separator plate 10 to have good electroconductivity to provide electrical connection between the adjacent cells 1. Moreover, the electrolyte membrane exhibits strong acidity and therefore, the separator plate 10 is required to have a property of corrosion resistance. For this reason, the separator plate 10 is currently formed by cutting a thin plate out of a graphite material and by forming a flow passage for supplying the reaction gas on both of the front and back sides of the separator plate 10 by performing cutting process while using a cutting tool such as an end mill.

However, the intervention of such mechanical processing during the course of production of a fuel cell becomes a significant cause of an increase in the manufacturing cost of the separator plate and hence the entire production cost of the fuel cell itself. Specifically, the shape of the reaction gas flow passage is diversified, fined and complicated depending on the type of fuel cells and therefore, mechanical processing must be precisely conducted on each of the separator plates as a production subject by controlling a cutting tool, i.e., an end mill corresponding to each flow passage pattern. Accordingly, this mechanical processing has been a major cause of an increase in the manufacturing cost of the separator plate. It is said that approximately 40% of the entire production cost of a fuel cell used as the power source for automobiles is attributed to the cost of the separator plate.

Therefore, an application of technique consisting of, for example, screen printing to the formation of a reaction gas flow passage has been proposed (Japanese Patent Application Laid-Open No. 2000-294257: Patent Document 1). The Patent Document 1 reveals that a rib for constituting a gas passage is formed by applying a conductive paste to a separator plate by the screen printing method, thereby making it possible to simplify the process of producing a fuel cell and reduce the production cost per se.

According to the screen printing, an ink composition used as a partition wall formation material for forming a flow passage is extruded from a printing mesh cloth to form a conductive ink layer having a relatively large thickness as the partition film defining a groove which is to be a flow passage of the reaction gas, on a material (on a separator plate) to be printed, thereby enabling a flow passage having various and desired patterns to be easily formed. Also, because the screen printing can be suited for any of a small lot and a large lot production form, this is an effective method for forming the gas passage with a three-dimensional pattern on the separator plate for fuel cell in the technical field of the present invention.

### SUMMARY OF THE INVENTION

### Problem to be Solved by the Invention

However, the flow passage of reaction gas arranged on the separator plate for a fuel cell is usually required to exactly and uniformly secure the necessary amount of flow gas which is defined and determined by the specification of each cell. For this reason, it is necessary that a three-dimensional pattern form of the flow passage of the reaction gas, that is to say, the width of the groove and the height of the partition wall are able to be formed with high accuracy and these formed pattern forms can be maintained without any change even after the fuel cell is fabricated. In light of this, since the groove which constitutes the flow passage of the reaction gas is formed by the partition wall formed of the ink composition in this screen printing method, there is a fear that the shapes of the partition wall and the groove are readily collapsed or damaged more than in the case of the afore-mentioned cutting processing due to fluidity of the ink composition, which is in the fluid state at the time of and immediately after printing. Further, the ink composition is gradually dried while being shrunk in its volume, so that the height of the initially applied ink composition by the screen printing is reduced to become lower after being dried in comparison with the initial height. Furthermore, in the screen printing technique, it is very technically difficult to apply, by the screen printing, a separate ink composition to the inside of any portion to which the ink composition is previously applied by the ink printing. Moreover, when the sectional shape of the groove is changed or any part of the edge of the partition wall is chipped or broken, causing the formation of a gas-leak part in the course of the flow passage, a desired amount of flow of the reaction gas is not obtained and therefore, a reduction or variation in the performance of the battery cannot be avoided.

The inventors of the present invention have made a preliminary test for an attempt to apply a conductive ink composition to the surface of a carbon plate by one screen printing operation using a printing mesh cloth having 18 openings, each having 0.8 mm in width, 22 mm in length and 0.3 mm in thickness to form a pattern of a reaction gas flow passage. However, the partition wall formed as the conductive ink layer was deformed and specifically, deformations such as collapsing and sagging were observed at the top thereof and also, indentations were formed at the end thereof, so that no pattern having a desired groove shape could be obtained. It was therefore found that it is very difficult to form a three-dimensional pattern form of the flow passage of the reaction gas, that is to say, the width of the groove and the height of the partition wall by one application of an ink composition even in the case where the screen printing method is adopted.

As mentioned above, in order to obtain a separator plate suitable for practical use by employing the screen plating method for the formation of the reaction gas flow passage of the separator plate for a fuel cell, it is absolutely required that a highly accurate pattern form indispensable for formation of the reaction gas flow passage can be always secured upon production of the pattern form.

It is, therefore, a primary object of the present invention to provide a method of producing a separator plate for a fuel cell, the method enabling the production of a practical, highly accurate, intact and fine gas flow passage on the separator plate used in a fuel cell by using the screen printing method.

Another object of the present invention is to provide a method of producing a separator plate for a fuel cell which is capable of forming a partition wall having a sufficient height thereof by means of small number of repetition of screen printing processes.

Still another object of the present invention is to provide a separator plate obtained by the above-mentioned production method and also to provide a fuel cell using the separator plate.

### Means for Solving the Problem

In order to solve the above-described problems, the present invention provides a method of producing a separator plate for a fuel cell, in which a partition wall having a predetermined pattern and defining a reaction gas flow passage is formed by applying a plurality of layers of conductive ink onto a base plate by printing the conductive ink in a gradual upward direction through plural times of screen printings, each of the conductive ink layers having a predetermined thickness, and the conductive ink consisting of an ink composition obtained by dispersing a mixture of a binder resin and a conductive material into a solvent, wherein the method comprises the steps of:

providing a plurality of printing screens which are preliminarily prepared to have a predetermined printing pattern, respectively, the predetermined printing patterns of the printing screens being intended for forming the separator wall and made to be different in width size thereof from one another;

conducting the screen printing by employment of a first one of the printing screens to thereby apply the ink composition with one predetermined pattern, via the first one of the printing screens, onto the base plate while permitting thereafter the ink composition to be dried so as to form one of the layers of conductive ink;

arranging a different one of the printing screens having a width size thereof narrower than that of the previously formed layer of conductive ink onto the said previously formed layer of conductive ink;

re-conducting the screen printing while employing the different one of the printing screens to thereby apply the ink composition onto the previously formed layer of conductive ink while permitting the applied ink composition to be dried so that the currently dried layer of conductive ink is formed as an upper side layer of conductive ink having a narrower width than that of the previously formed layer of conductive ink that is a lower side layer of conductive ink; and,

performing, in a plurality of times of repeated manner, the afore-described steps of conducting, arranging and re-conducting until the partition wall formed of the layers of the conductive ink and having a predetermined height thereof is finally produced.

Also, in order to solve the above-described problem, the invention provides a further method of producing a separator plate for fuel cell, in which the method according to claim 1 further including the step of performing heat treatment for thermally decomposing a binder resin contained in the conductive material after all of the conductive ink layers provided for constituting the partition wall have been formed.

Further, in order to solve the above-described problem, the invention provides a separator plate for fuel cell which is obtained by the method of producing a separator plate for the fuel cell.

Still further, in order to solve the above-described problem, the invention provides a fuel cell including therein the separator plate for the fuel cell.

### Effect of the Invention

In accordance with the present invention, the three-dimensional pattern of each of the partition walls provided for defining the reaction gas flow passages can be formed with high accuracy without any defects by the screen printing method and therefore, the present invention can enjoy such a remarkable effect that production cost of a separator plate and hence the production cost of an entire assembly of fuel cell can be appreciably curtailed.

### BRIEF DESCRIPTION OF THE DRAWINGS

FIG. 1 is a flowchart of an embodiment of a method of producing a separator plate for fuel cell according to the present invention.

FIG. 2 is a sectional view of a separator plate formed with a pattern of a reaction gas flow passage.

FIG. 3 is a cross-sectional view of a separator plate provided with partition walls formed of conductive ink layers arranged in a manner such that an upper side layer has a width thereof narrower than that of a lower side layer.

FIGS. 4A-4E schematically illustrate a case where the conductive ink layers are stacked one on another by performing the process of screen printing plural times while employing an identical printing screen.

FIGS. 5A-5D schematically illustrate a case where the conductive ink layers are stacked one on another by performing the process of screen printing plural times while employing a plurality of printing screens in which an upper side printing screen has a printing pattern with its width narrower than that of a printing pattern of a lower side printing screen.

FIG. 6 is a plan view of a separator plate.

FIG. 7 is a graphical view illustrating the relation between the number of printings and the total thickness of conductive ink layers on a separator plate produced by the method of the present invention.

FIG. 8 is a graphical view illustrating the relation between the film thickness of a conductive ink layer formed by the method according to the present invention and electric resistance of the conductive ink layer.

FIG. 9 is a graphical view illustrating the result of comparison of performance of a separator plate between one printing-made type separator plate and a commercially available separate type separator plate when these separators are both subjected to drying or desiccation at 140° C. for 10 minutes.

FIG. 10 is a graphical view illustrating the result of comparison of performance of a separator plate between both of the respective types of separator plates after the aging shown in FIG. 9.

FIG. 11 is a graphical view illustrating the result of comparison of performance of a separator plate between a printing-made type separator plate and a commercially available separator plate when both of the two types of separators are subjected to heat and pressing treatments by application of pressing to the separator plates at 140° C.

FIG. 12 is a graphical view illustrating the result of comparison of performance of a separator plate between a printing-made type separator plate and a commercially available separator plate when these separators are subjected to heat and pressing treatment by application of pressing to the two types of separator plate at 250° C.

FIG. 13 is a schematic view illustrating the structure of a unit cell to be incorporated in PEMFC.

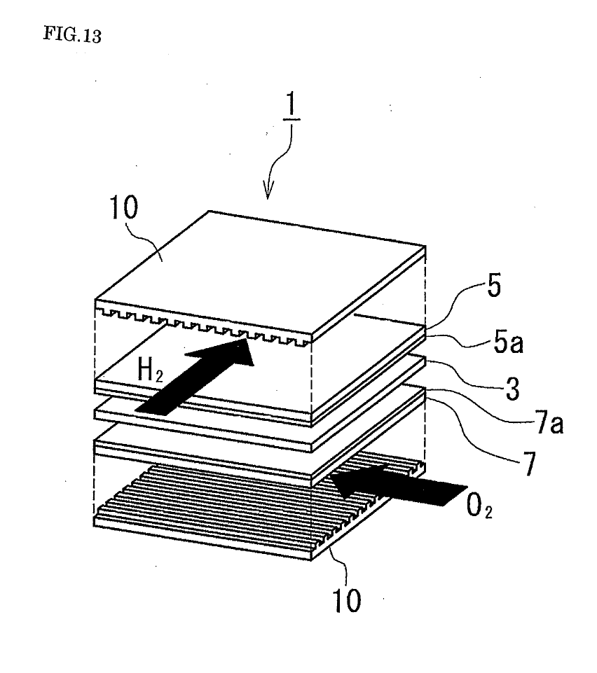

### DESCRIPTION OF REFERENCED PARTS BY NUMERALS

1: Cell
3: Electrolyte membrane
5: Hydrogen electrode
5a: Support current collector
7: Oxygen electrode
7a: Support current collector
10: Separator plate
10a: Base plate
11: Partition wall
11a to 11e: Conductive ink layers
13: Flow passage formation part
15: Groove
20: Gasket
20a to 20e: Gasket layers
21: Unprinted part
23: Manifold hole
25: Bolt hole
30a, 30b and 30c: printing screen

### BEST MODE OF CARRYING OUT THE INVENTION

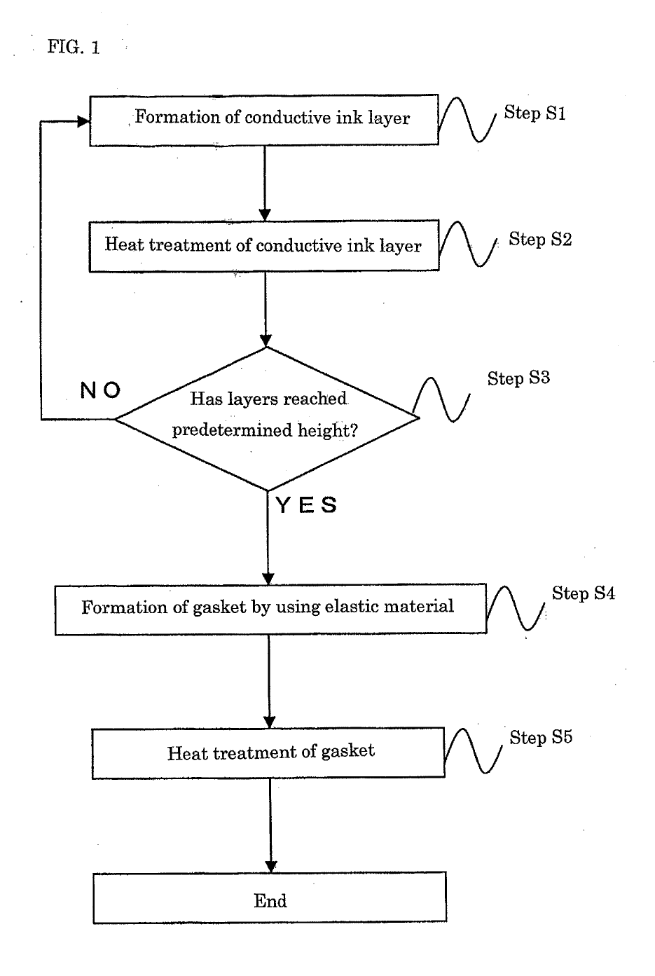

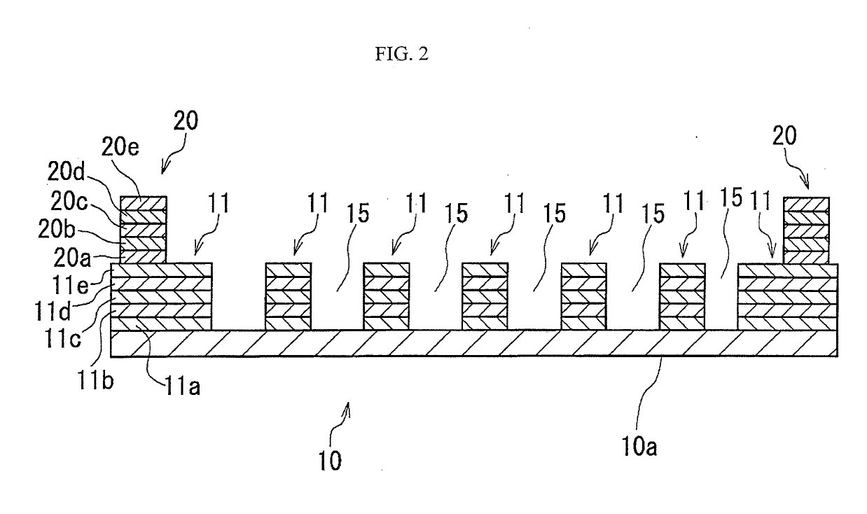

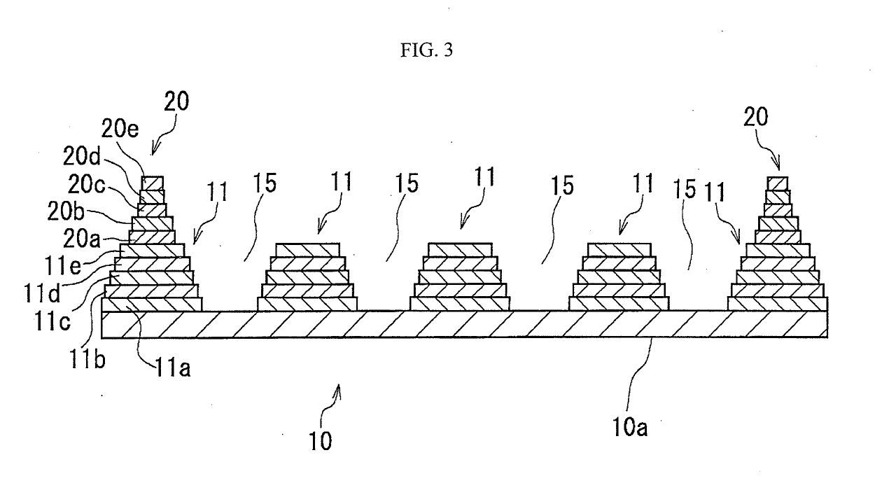

A method of producing a separator plate for a fuel cell according to the present invention and a fuel cell utilizing the separator plate will be described in detail with reference to the attached drawings. FIG. 1 is a flowchart for illustrating a method of producing a separator plate for a fuel cell according to an embodiment of the present invention, FIG. 2 is a cross-sectional view of a separator plate formed thereon with a pattern for defining a reaction gas flow passage, and FIG. 3 is a cross-sectional view of a separator plate provided with partition walls formed of conductive ink layers arranged in a manner such that an upper side layer has a width thereof narrower than that of a lower side layer.

First, an ink composition to be used as a printing ink employed by the method of producing a separator plate for a fuel cell according to the present invention is constituted by blending a resin component as a binder, a conductive material such as graphite or carbon black as a conductive filler, a solvent and an appropriate well known adjuvant as needed.

These components may be mixed or blended by kneading them using a suitable roll mill or the like. As to the conductive material to be mixed, an amount thereof is preferred to be as large as possible in consideration of printing operation per se and volumetric shrinkage of the ink composition when the separator plate is dried. However, if the proportion of the conductive material is increased, the fluidity of the ink composition is reduced, making printing operation difficult. In this case, the fluidity can be improved by supplying an additional amount of the solvent during blending. However, if the amount of the solvent to be blended is too large, an undesirable matter must occur such that the volume of the conductive ink layer is decreased when the plate is dried.

As the printing mesh cloth used in the screen printing, a proper one is selected in consideration of, for example, the amount of the ink composition passing therethrough and the state of the shape of the conductive ink layer. The screen mesh is preferably about 100. When the value of the mesh is large, the amount of the ink to be transferred is reduced whereas when the value of the mesh is small, the shape characteristics are deteriorated. In the case of, for example, a 50-mesh printing mesh cloth, there is a large possibility of generation of the groove pattern having indentations.

An opening pattern corresponding to a desired pattern of the reaction gas flow passage is formed on the printing mesh cloth and then the ink composition is extruded by a squeegee to apply the ink composition to a base plate 10a which is a material to be printed, to thereby form a partition wall 11 defining a groove 15 which is to be the reaction gas flow passage by conductive ink layers 11a to 11e which are respectively a printed coating film of the ink composition (step S1).

As the base plate 10a, an arbitrary material used as the separator in conventional fuel cells, for example, a carbon plate may be used. In conventional technologies, a groove having a desired pattern is formed on such a carbon base plate by an end mill or the like. This, however, is a main cause of increase in the production cost of the separator and hence in the production cost of a fuel cell. In the case of fuel cells used in applications for which long term durability is not required, a metal material such as stainless steel may be used as the base plate.

In the present invention, on the other hand, a pattern corresponding to the reaction gas flow passage having a predetermined form is printed on a printing mesh cloth, and using this screen, a process in which one pass printing is made on the base plate 10a is carried out. It is only necessary in the present invention to repeat this process two or more times, and therefore, the processing is significantly simple and also, it is unnecessary to introduce a large-scale mechanical processing assembly, making it possible to reduce the production cost remarkably.

The partition wall 11 formed by the screen printing is easily deformed or collapsed during printing or just after printing due to the fluidity of the ink composition, and there is therefore a fear that the sectional shape of the groove 15 is changed and the end of the partition wall 11 is chipped. In the case where a leak area arises between the reaction gas flow passages, a desired amount of gas is not obtained. Therefore, in the present invention, the conductive ink layers 11a to 11e are formed by applying a conductive ink layer two or more times in an overlapped manner when the partition wall 11 having a predetermined height is formed. Specifically, a flow passage pattern is formed by relatively thin conductive ink layers 11a to 11e in each screen printing and the coating of each of the conductive ink layers 11a to 11e is repeated until the partition wall 11 having a desired height is obtained. According to this method, the conductive ink layers 11a to 11e each formed by one printing operation are low in thickness, so that the shape of the ink layer is relatively stable, which reduces a fear that defects such as “crack” and “peeling” are generated.

Also, heat treatment is carried out for drying or desiccating the conductive ink layer 11a prior to the printing of the conductive ink layer 11b subsequent to the first conductive ink layer 11a that was previously formed (Step 2). As best shown in FIG. 2, after the conductive ink layer 11a is dried under heating, a similar conductive ink layer designated at 11b is coated and formed on the conductive ink layer 11a by the subsequent printing step, and this process is repeated two or more times. This repeated coating results in typical reduction in occurrence of collapse and deformation of the shape as a whole as compared with the conventional one-time coating method, ensuring that the partition wall 11 reduced in defects such as crack, peeling and tearing can be formed (Step 3).

Even in the case of this repetition of coating operation, there is a case where “sagging” and the like are increased at the printed part on the upper layer side depending on the pattern shape and the width of the conductive ink layers 11a to 11e so that the shape of the partition wall 11 is not stable with increase in the height of the partition wall 11 resulting from an increase in the number of repeated coatings.

In this case, as shown in FIG. 3, it is preferred that the conductive ink layers 11a to 11e are produced in a manner such that the respective printing widths thereof come to be gradually narrower from the lower layer side toward the upper layer side during the repetitive coating process. At this stage, it should be appreciated that in order for the printing widths of the conductive ink layers 11a to 11e to be gradually narrower from the lower layer side toward the upper layer side, a plurality of printing mesh cloth patterns narrowed so as to correspond to the above-described layers are preliminarily prepared and used by turns, making it possible to obtain intended conductive ink layers for defining required partition walls 11.

That is to say, it should be noted that in case of producing the partition walls 11 by performing a plurality of screen printing operations, if ink composition layers are coated in succession such that, onto a surface of one ink composition applied by coating due to employment of a certain printing screen, a subsequent ink composition is also applied by coating while employing the identical printing screen, the upper layer side of the ink composition cannot be coated to have the height thereof identical with that of the lower layer side of the ink composition.

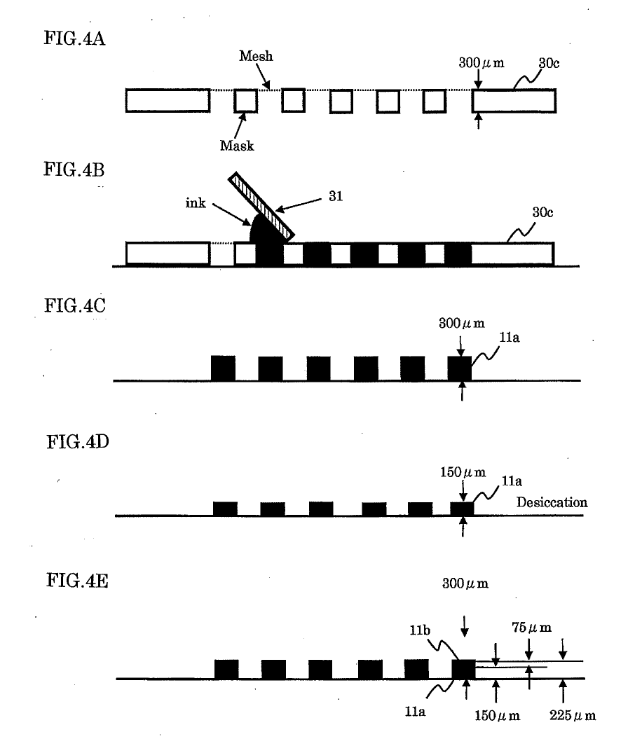

In this connection, a detailed description of a case where a printing screen 30c having printing height of 300 μm as indicated in FIG. 4A is employed for performing plural times of coating operations will be provided below. First of all, as shown in FIG. 4B, when an ink composition is coated, via the printing screen 30c, on the surface of an appropriate base plate by the screen printing employing a squeegee 31, a conductive ink layer 11a with its height of 300 μm as indicated in FIG. 4C, is produced as a lowest layer of the ink composition. The produced lowest conductive ink layer 11a is then subjected to a treatment of desiccating or drying so that the volume thereof is reduced resulting in that the height of the conductive ink layer 11a is lowered to approximately a half of the initial height as shown in FIG. 4D. Therefore, it is understood that even if the coating of the ink composition is the first time performed so as to have the coating thickness of 300 μm, the ink composition layer 11a of 150 μm height is produced due to desiccation. Accordingly, in a case where a further ink composition layer is coated onto the ink composition layer 11a by employing a printing screen identical with the previously used printing screen 30c, a subsequent ink composition layer 11b is produced onto the surface of the previously produced ink composition layer 11a on the lower layer side, and as a result, the coating of ink composition for the subsequent ink composition layer is restricted to a state where the coated layer of the ink composition has mere 150 μm in its thickness (300 μm−150 μm). This brings about such a situation that, as shown in FIG. 4E, the conductive ink layer 11b formed by the second coating operation is permitted to have a layer height of only 75 μm after desiccation, i.e., a half of the above-mentioned coated thickness of 150 μm.

Although not illustrated, a third time screen printing, if performed, will result in such a undesirable situation that the thickness of the conductive ink immediately after coating is 75 μm, namely, an amount of 300 μm−(150 μm+75 μm). Thus, when this thrice conductive ink layer of 75 μm in its thickness is subjected to drying operation, the height of the thrice conductive ink layer will be reduced to 37.5 μm due to desiccation. Accordingly, it will be readily understood that when an identical kind of printing screen 30c (see FIG. 4A) is employed two or more times for performing production of plural conductive ink layers stacked one above another for the purpose of eventually producing the partition wall 11, it is quite difficult from technical view point to build an ink composition layer on an upper layer side in a manner such that the height thereof is substantially the same as that of an ink composition layer formed on the adjacent lower layer side. For this reason, many times of repetition of screen printing operation will be necessarily but inconveniently required for the production of each of respective partition walls 11.

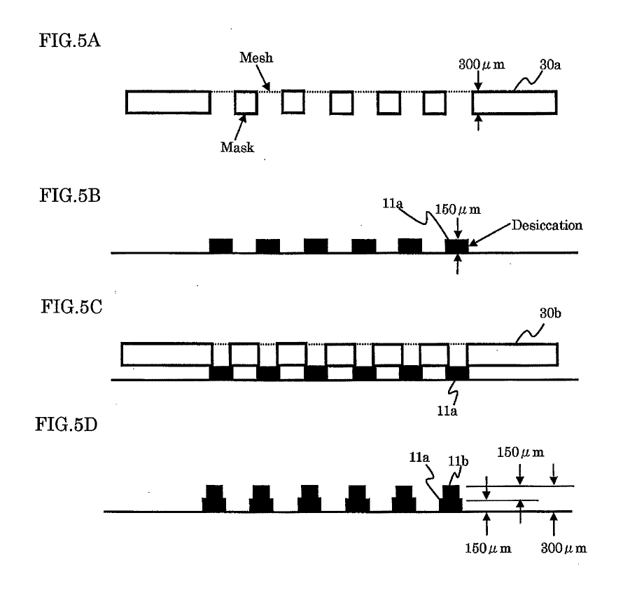

Therefore, to obviate such an inconvenience, the present invention was made in which an improved method was implemented as will be understood from the following description of an example thereof, with reference to FIGS. 5A-5D. Namely, as shown in FIG. 5A, a printing screen 30a having 300 μm printing height is initially employed for coating a conductive ink layer 11a on the lowermost layer side, so that the conductive ink layer 11a is reduced in its height to 150 μm due to desiccation as was described in connection with the process of FIG. 4A-4E. Then, onto the surface of the conductive ink layer 11a, a subsequent conductive ink layer 11b is coated by employing another printing screen 30b which has a printing width narrower than that of the former printing screen 30a. At this stage, it should be noted that in the process of implementing the screen printing operation by which respective printed layers are stacked one above the other, if the lower side printing screen 30a having a broader printing width and the upper side printing screen 30b having the printing width narrower than that of the lower side printing screen 30a are employed, the upper side printing screen 30b must be arranged so as to come in contact with the conductive ink layer 11a produced by the employment of the lower side printing screen 30a. This is because the upper side printing screen 30b cannot be arranged to come into contact with the surface of a base plate owing to existence of the formerly produced conductive ink layer 11a and is merely allowed to come in contact with the surface of the conductive ink layer 11a. This situation always occurs as far as an upper side printing screen having its printing width which is made narrower than that of a lower side printing screen is employed. As a result, the upper side conductive ink layer 11b coated and produced by the screen printing operation employing the printing screen 30b can have its thickness of 300 μm, and even after desiccation and shrinkage, the upper side conductive ink layer 11b can be produced to have its height of not lower than 150 μm.

Accordingly, in accordance with the present invention, there is first prepared a plurality of printing screens provided therein with respective printing patterns that are designed and determined in compliance with the predetermined dimensional condition of a desired partition wall and are changed in their pattern sizes from one another. Then, coating of ink composition having a predesigned pattern is applied onto a base plate through one of the prepared printing screens which has therein the predesigned printing pattern by means of the screen printing operation and subsequently, the coated ink composition is subjected to drying or desiccating so as to produce an initial conductive ink layer 11a. As soon as completion of production of the conductive ink layer 11a, a different printing screen provided with a printing pattern having a width of which the size is narrower than that of the pattern of the firstly produced conductive ink layer 11a is disposed on that previously produced conductive ink layer 11a, and the ink composition is coated through the disposed printing screen onto the conductive ink layer 11a by means of the screen printing operation. The coated ink composition is thereafter subjected to desiccating or drying, so that a different conductive ink layer 11b having a width of which the size is narrower than that of the conductive ink layer 11a may be produced above that conductive ink layer 11a as an upper side layer. These coating and drying or desiccating operations described above are repeatedly performed plural times. As a result, one of the partition walls 11 constituted by the conductive ink layers 11a through 11e which are coated and built to show a desired height from the surface of the base plate can be eventually produced as shown in FIG. 3, in spite of an appreciably small number of repetitions of the coating and drying operations.

In conclusion, it should be appreciated that the employment of printing screens provided with respective printing widths which are different from one another in a manner such that one printing width suitable for coating an upper layer side is always narrower than another printing width suitable for coating the adjacent lower layer side can surely contribute to a production of the conductive ink layers of identical height thereof every time and also to a lessening of the number of repetition of the coating processes.

In the fuel cell according to the present invention, the binder resin which is a constituent material of the ink composition is decomposed by the heat generated by current and chemical reaction in the operation, and there is a fear as to poisoning of the catalyst contained in the electrode, resulting in deteriorated performance. For this reason, it is preferable to carry out heat treatment after the reaction gas flow passage is formed on the separator plate 10 by the conductive ink layers 11a to 11e to prevent generation of the poisoning. The heat treating temperature in this case differs depending on the structure of the ink composition to be used. However, the decomposition temperatures of most binder resins are in the range of 250° C. to 300° C. and the removing effect to be intended is obtained by carrying out heat treatment at a predetermined temperature in the above range according to the type of binder resin used.

This heat treatment may be carried out each time after the printing of each of these conductive ink layers 11a to 11e is completed. The ink composition is thereby cured under heating each time when each layer is formed by the screen printing and therefore, the effect of stabilizing the shape of the partition wall owing to the recoating is more increased.

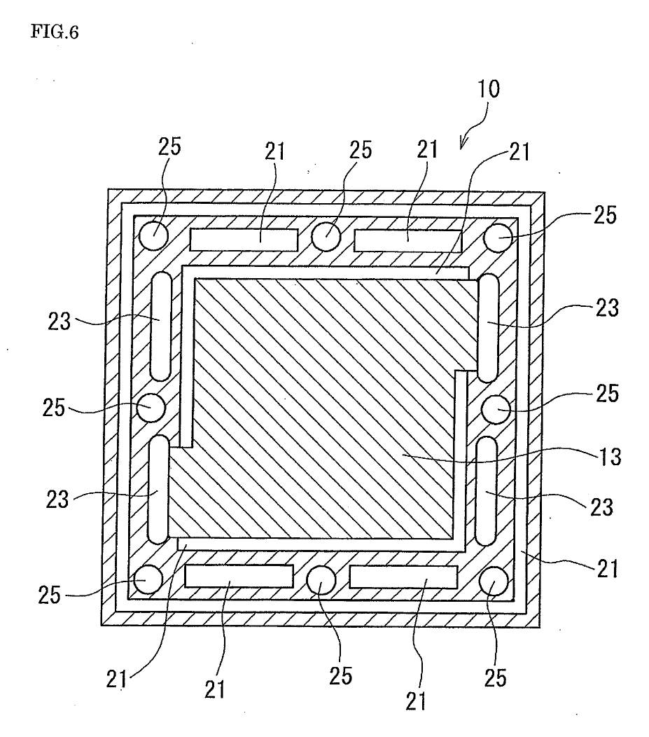

On the other hand, the amount of the ink composition to be used can be saved by providing a place free from printing at a part other than the part where the groove 15 which is to be the reaction gas flow passage is formed by the conductive ink layers 11a to 11e. Specifically, as shown in FIG. 6, the provision of an unprinted place 21 free from printing at the peripheral part other than the flow passage formation part 13 which is the part where the groove 15 to be the reaction gas flow passage on the base plate 10a is formed allows saving in the amount of use of the ink composition. Also, a positioning effect may be expected which is due to the engagement between the part where no printing is made and the pattern of the printing mesh cloth. Reference numeral 23 in FIG. 6 designates a manifold hole and, a bolt hole is designated at 25.

After the formation of the groove 15 which is to be the gas flow passage is finished, an elastic material having elasticity is applied in a predetermined thickness to the peripheral part of the separator plate by the screen printing in the same manner as in the formation of the conductive ink layers 11a to 11c to thereby form a gasket 20 with a predetermined pattern (Step S4). Because it is necessary to form the groove 15 with high accuracy in the case of the conductive ink layers 11a to 11e forming the flow passage pattern, it is designed to make two or more printings. However, in the case of the gasket, the number of printings is not particularly limited because, unlike the case of the flow passage, it is only necessary to firmly seal the gasket even if there are slight indentations at the edge. It is needless to say that like the case of the conductive ink layers 11a to 11e, exact gasket layers 20a to 20e can be formed by separate two or more printings. Then, after the pattern of the gasket 20 is formed, the same heat treatment as above is performed so as to prevent the catalyst in the electrode from being poisoned by resin components contained in the elastic material (Step S5). In the case of the gasket 20, if it is exposed to such a high-temperature atmosphere as to thermally decompose resin components, there is a fear that the sealing ability of the gasket is impaired, and it is therefore preferable to carry out heat treatment at a temperature which barely allows the resin components to proceed with the reaction.

### EXAMPLE 1

### Production of a Gas Flow Passage by Printing of a Conductive Material on a Carbon Separator

### Method of Producing an Ink Composition

In order to measure the data of properties of materials, 10 g of graphite was added to 50 g of “DOTITE” (manufactured by Fujikura Kasei Co., Ltd.) using a polyester resin as the binder resin and these components were mixed using a mixer capable of stirring with centrifugal rotation. The mixture was granulated and mixed by a three-roll mill to prepare a printing ink composition.

Using a 100-mesh screen, printing precursor plates having a pattern of a groove to be a predetermined gas flow passage were produced to make screen printing necessary times. Specifically, the ink composition was formed on a carbon plate by printing using a squeegee in such a manner as to obtain a conductive ink layer 25 μm in thickness each time to form each layer. This printing step was repeated 20 times at specified intervals to obtain a partition wall having a total height (thickness) of 500 μm. After each printing step, the plate was heated to 140° C. to vaporize solvent to dry. In this case, there were prepared several printing mesh cloth patterns made different such that the printing width of the upper layer is more decreased each time each layer is formed by printing.

After the pattern of the flow passage was formed, the separator plate was heated to about 270° C. to prevent the catalyst from being poisoned by catalyst poisoning components generated by thermal decomposition of the binder resin in the pattern of the conductive ink layer during use of the fuel cells. This heat treatment may be carried out every time the formation of one conductive ink layer is finished. This makes it possible to more stabilize the shape of each layer in the recoating.

After the gas flow passage was formed, a gasket pattern was formed on the periphery of the separator plate by the screen printing method using a silicon rubber type composition “RTV” (manufactured by Shin-Etsu Silicones) in the same manner as above and then, the same heat treatment as above was carried out. In the case of “RTV”, although a curing reaction proceeds at ambient temperature, heat treatment may be optionally carried out to accelerate the reaction.

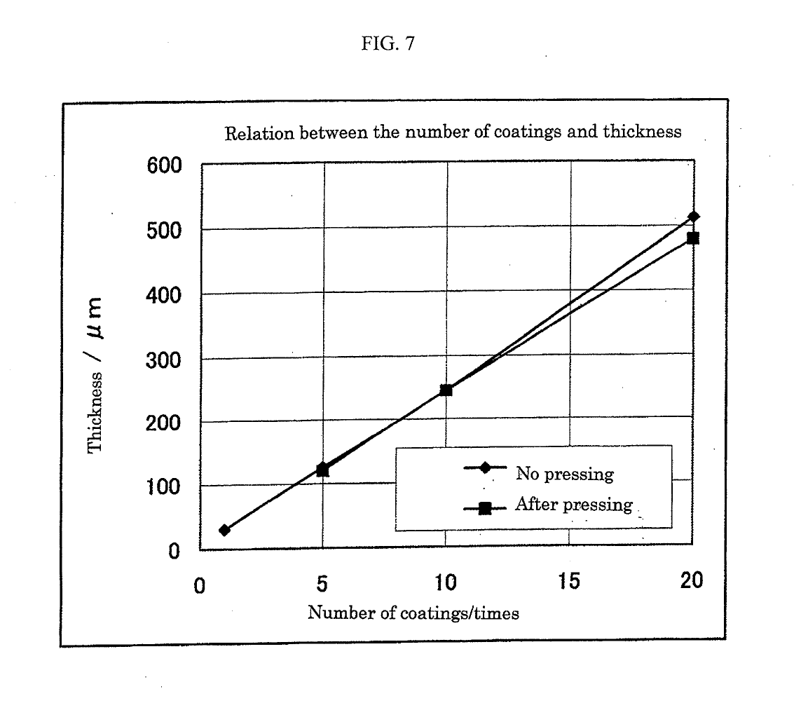

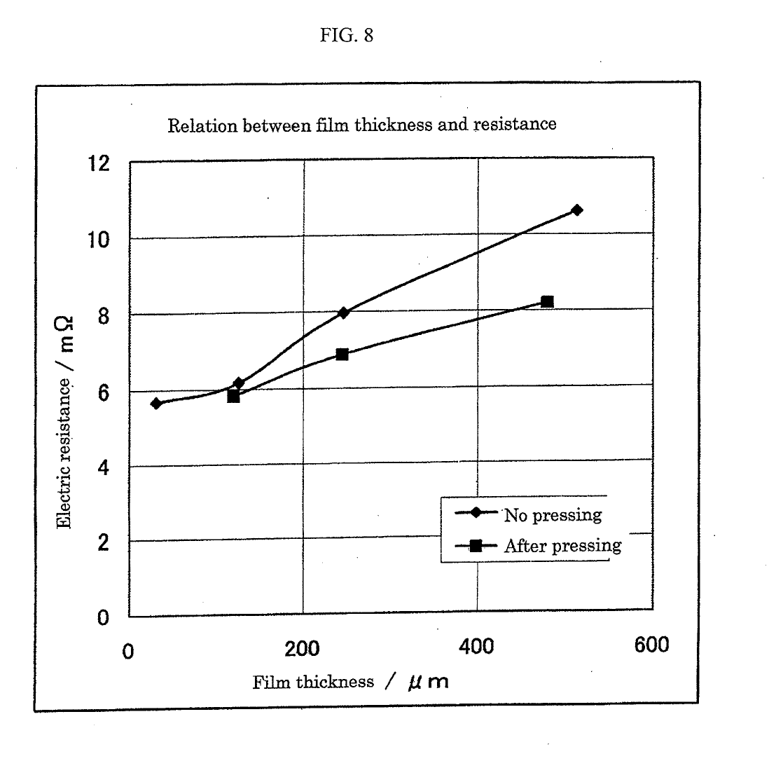

The separator plate obtained in this manner has formed thereon a groove 15 which is to be a gas flow passage having a desired shape by a partition wall 11 free from collapsing and deformation as shown in FIG. 2. Also, it was confirmed that the thickness of the partition wall 11 of the reaction gas flow passage was linearly increased corresponding to the number of recoatings of the conductive ink layers (see FIG. 7). Also, although the increase in the thickness of the coating layer due to recoating is accompanied by an increase in electric resistance, the increase in resistance can be limited by pressure and heating treatment using press treatment (see FIG. 8).

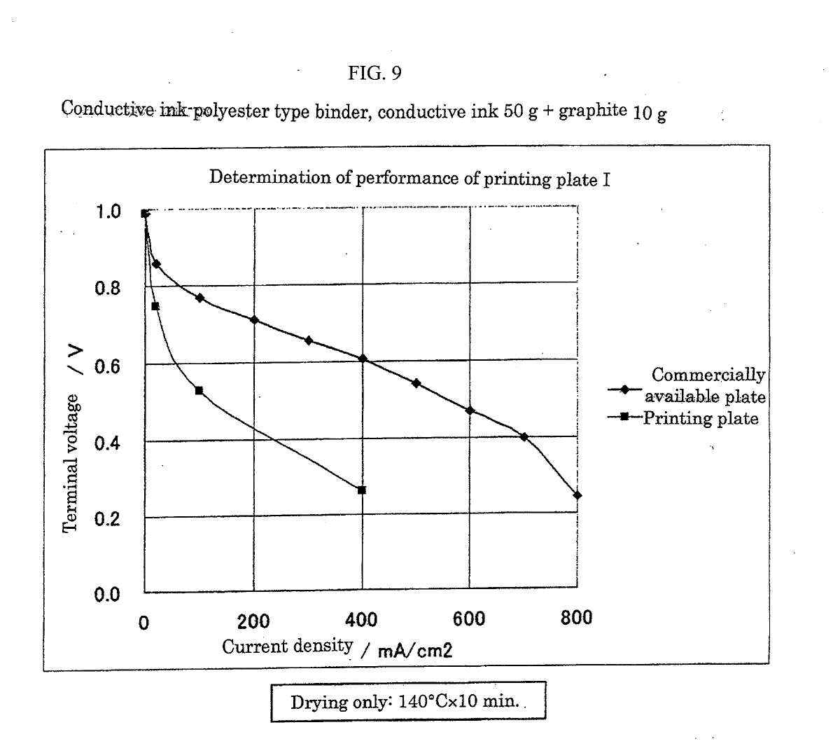

The influence of poisoning caused by the decomposition of resin components as the binder contained in the ink composition is shown in FIG. 9. FIG. 9 is a graphical view indicating the result of comparison of performance between a separator plate and a commercially available separator plate when these separators are dried at 140° C. for 10 minutes using polyester resin as a binder. The result clearly shows the influence of poisoning caused by the resin components.

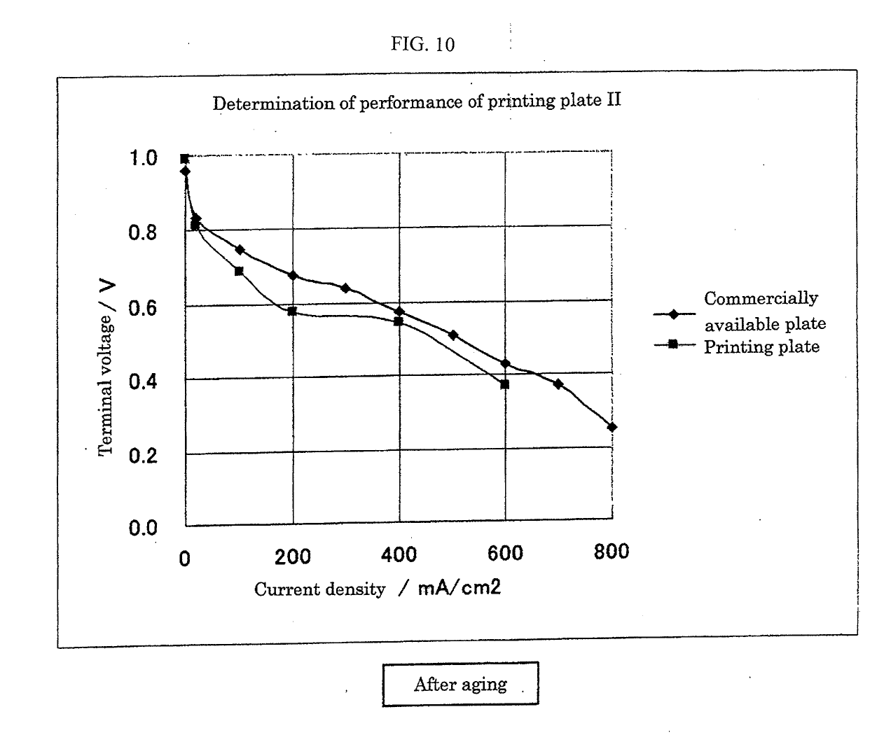

On the other hand, FIG. 10 is a graphical view indicating the result of comparison of performance between the both separator plates after the aging is carried out at 80° C. at a current density of 600 mA/cm². Although it is shown that the influence of poisoning caused by the resin components is reduced by the aging, this separator plate has a more unstable performance than the commercially available separator plate. In light of this, the separator plate was subjected to heat treatment performed under pressure by press treatment in the conditions of 140° C., 1 MPa and 1 min. and 250° C., 1 MPa and 1 min.

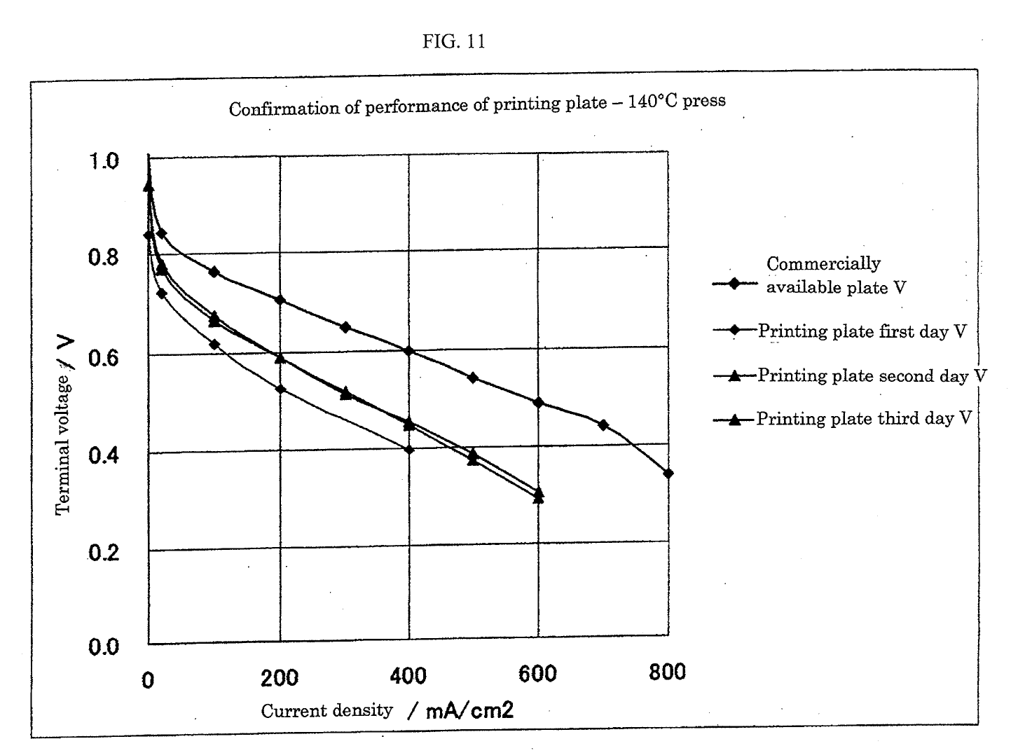

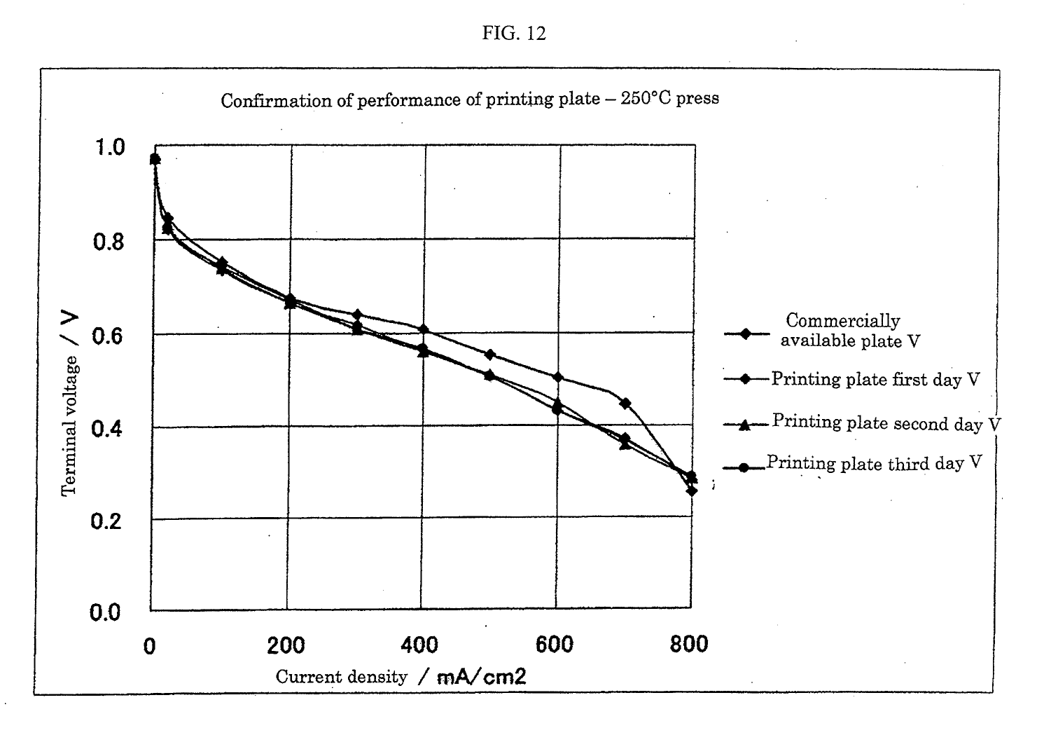

As a result, as indicated in FIG. 11, a difference in performance was observed between the separator plate treated at 140° C. and the commercially available separator plate. On the other hand, it was found that the separator plate treated at 250° C. could exhibit the same performance as the commercially available separator plate, as indicated in FIG. 12.

Using the separator plate obtained in this manner in place of the separator plate of a commercially available fuel cell, a unit fuel cell was fabricated to measure cell output, with the result that the output characteristics almost equal to those of the commercially available product were obtained as shown in Table 1, showing that the obtained fuel cell sufficiently copes with practical use. In addition, it will be readily understood by a person skilled in the art that the separator plate 10 as shown in FIG. 3 can show a similar advantageous effect to the above-described effect.

TABLE 1

Current density mA/cm²

| | 0 | | | |
|---|---|---|---|---|
| | (Open | | | |
| | circuit) | 20 | 400 | 600 |
| Example | 0.993 | 0.812 | 0.544 | 0.374 |
| Comparative | 0.958 | 0.831 | 0.575 | 0.431 |
| Example | | | | |

1. A method of producing a separator plate for a fuel cell, in which a partition wall having a predetermined pattern and defining a reaction gas flow passage is formed by applying a plurality of layers of conductive ink onto a base plate by printing the conductive ink in a gradual upward direction through plural times of screen printings, each of the conductive ink layers having a predetermined thickness, and the conductive ink consisting of an ink composition obtained by dispersing a mixture of a binder resin and a conductive material into a solvent, wherein the method comprises the steps of:
providing a plurality of printing screens which are preliminarily prepared to have a predetermined printing pattern, respectively, the predetermined printing patterns of the printing screens being intended for forming the separator wall and made to be different in width size thereof from one another;
conducting the screen printing by employment of a first one of the printing screens to thereby apply the ink composition with one predetermined pattern, via the first one of the printing screens, onto the base plate while permitting thereafter the ink composition to be dried so as to form one of the layers of conductive ink;
arranging a different one of the printing screens having a width size thereof narrower than that of the previously formed layer of conductive ink onto the said previously formed layer of conductive ink;
re-conducting the screen printing while employing the different one of the printing screens to thereby apply the ink composition onto the previously formed layer of conductive ink while permitting the applied ink composition to be dried so that the currently dried layer of conductive ink is formed as an upper side layer of conductive ink having a narrower width than that of the previously formed layer of conductive ink that is a lower side layer of conductive ink; and,
performing, in a plurality of times of repeated manner, the afore-described steps of conducting, arranging and re-conducting until the partition wall formed of the layers of the conductive ink and having a predetermined height thereof is finally produced.

2. The method of producing a separator plate for a fuel cell according to claim 1, further comprising:
performing heat treatment for thermally decomposing the binder resin contained in the conductive material after all of the layers of conductive ink which are to be the partition wall have been formed.

3. A separator plate for a fuel cell, the separator plate being obtained by the method of producing a separator plate for a fuel cell according to the claim 1.

4. A fuel cell incorporating therein the separator plate for a fuel cell according to claim 3.
